(19) United States
(12) Patent Application Publication
(10) Pub. No.: US 2023/0150890 A1
(43) Pub. Date: May 18, 2023

(54) FOAMED MATERIAL INFILTRATED WITH HIGH TEMPERATURE CERAMIC

(71) Applicant: ERG Aerospace Corporation, Oakland, CA (US)

(72) Inventors: James ASTRACH, Glenwood Springs, CO (US); Alexander Frazier PARKE, Sparks, NV (US)

(21) Appl. No.: 18/053,697

(22) Filed: Nov. 8, 2022

Related U.S. Application Data
(60) Provisional application No. 63/280,570, filed on Nov. 17, 2021.

(51) Int. Cl. C04B 38/00; C04B 41/00; C04B 41/87; C04B 41/45; C04B 41/50

(52) U.S. Cl. CPC C04B 38/0096; C04B 38/0058; C04B 41/009; C04B 41/50; C04B 41/0072; C04B 41/87; C04B 41/4539

(57) ABSTRACT

An open cell reticulated foam structure having a MAX phase ceramic material infiltrated at least partially into the foam structure to produce the infiltrated product. The open cell reticulated foam structure can be shaped and sized to the final shape and size of the final product prior to infiltrating with the MAX phase ceramic material. Sintering of the MAX phase ceramic material can be done with pressureless sintering. The final infiltrated product can provide heat shielding to temperatures in excess of 2400° C.

### CROSS-REFERENCE

This application claims priority to U.S. Provisional Application Serial No. 63/280,570 filed Nov. 17, 2021 and titled INORGANIC RETICULATED FOAM STRUCTURE WITH HIGH TEMPERATURE MAX PHASE COATING, the entire disclosure of which is incorporated herein by reference for all purposes.

### BACKGROUND

Inorganic reticulated open cell foam structures are open cell patterns or lattices that enable gas, air, or other medium to pass between solid ligaments. These materials are suitable for ultra-high temperature applications.

Currently, open cell reticulated foam structures are manufactured using a number of different manufacturing methods. Methods of making an inorganic reticulated foam structure is described by U.S. Pat. 3,616,841; these processes provide solid reticulated structures such as metals, ceramic, cermet, graphite and carbon structures for high temperature applications. Other open cell reticulated foam materials that may also be used to support high temperature applications are manufactured from ceramic; these materials may be manufactured using chemical vapor deposition and other manufacturing methods. Typically, ceramic open cell materials can withstand high temperature differentials; they can with stand temperatures up to 1800° C. before experiencing material fatigue and fracturing.

There are also coatings that can be applied to open cell reticulated structures to increase thermal performance. Applying these coatings, however, can be a challenge. Additionally, typically, layered solids (those having a coating) lack ductility.

Solutions are needed to decrease the costs of using MAX phase ceramics and to address the process issues associated with utilizing the materials. Furthermore, increased performance at high temperatures is sought after to support high temperature environments such as hypersonic missiles, booster motors, and other ultra high temperature systems.

### SUMMARY

The present disclosure provides a low cost solution to production of high temperature products, by providing open cell reticulated foam structures having a MAX phase ceramic material thereon or at least partially infiltrated therein.

The product can be shaped prior to final sintering, thus avoiding the need for expensive and time consuming machine or other shaping of the product. In some processes, the open cell reticulated foam is shaped and sized to the shape and size of the final product prior to applying the MAX phase ceramic material. In such a manner, a near net shape is provided prior to sintering.

The final, infiltrated product can provide heat shielding to temperatures in excess of 2400° C.; the amount of heat shielding can be tailored by the MAX phase ceramic material used and the depth of infiltration into the open cell foam structure.

In addition to the natural cooling provided by the open cells of the foam structure opposite the MAX phase ceramic material, the infiltrated product can be actively cooled by passing a cooling medium such as air, water, glycol type coolant, or sodium and sodium-type materials through the open cells pores of the foam structure.

In one particular implementation, this disclosure provides a product comprising an open cell reticulated foam structure comprising a plurality of ligaments forming a plurality of pores and a MAX phase ceramic material infiltrated into the foam structure and present on the ligaments and coating interior and optionally exterior surfaces of the pores. The foam structure may be, for example, a polymeric foam, a metal foam, a metal nitride or carbide foam, carbon or graphite foam, or a ceramic foam.

In yet another particular implementation, this disclosure provides a method of making an infiltrated product. The method comprises providing an open cell reticulated foam structure, infiltrating a MAX phase ceramic material at least partially into the open cell reticulated foam structure, and after infiltrating the MAX phase ceramic material into the foam structure, sintering the MAX phase ceramic material at near vacuum reactor pressure, e.g., less than 5 psi.

These and other aspects of the materials described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE FIGURES

FIG. 1 is a perspective, close-up view of an open cell reticulated foam structure.

FIG. 2 is a schematic, perspective view of an example MAX phase ceramic infiltrated open cell reticulated foam structure.

FIG. 3 is a schematic, perspective view of another example MAX phase ceramic infiltrated open cell reticulated foam structure.

FIG. 4 is a photomicrograph of cross-section of an example MAX phase ceramic infiltrated open cell reticulated foam structure.

FIG. 5 is a perspective view of an example infiltrated product.

FIG. 6 is a schematic representation of a step-wise method for making an example MAX phase ceramic infiltrated open cell reticulated foam structure.

FIG. 7 is a graphical representation of a temperature profile of an example MAX phase ceramic infiltrated open cell reticulated foam structure.

### DETAILED DESCRIPTION

As indicated above, the present disclosure is directed to materials composed of an open cell reticulated foam structure having a MAX phase ceramic coating at least partially infiltrated therein and methods of making the infiltrated product. The infiltrated products can provide heat shielding to temperatures in excess of 2400° C.

The MAX phase ceramic material may be present as a layer over the open cell reticulated foam structure, or at least partially infiltrated into the open cell reticulated foam structure, bonding to the ligament structure of the open cell reticulated foam structure. One or multiple surfaces of the open cell reticulated foam structure may be coated or infiltrated to achieve the desired thermal performance. Leaving a section of the open cell foam structure un-infiltrated with the MAX phase ceramic material provides open channels that can be used for various cooling methods. The reticulated foam structure can be tailored to the desired design strength by increasing or decreasing the thickness of the ligaments in the foam structure and/or the pore volume and/or the porosity. The thickness of the MAX phase ceramic material, either the thickness of the material into the foam structure or the thickness of the material on each of the ligaments, can be tailored to obtain the desire thermal performance of the infiltrated product.

The combination of the MAX phase ceramic material and the open cell reticulated foam structure provides an infiltrated product having nonlinear, hysteretic, elastic behavior, which is unusual for stiff compounds. The infiltrated product is capable of withstanding high temperature and high-pressure environments. The infiltrated product is ideal for transportation systems such as aircraft, space vehicles, thermal shielding, and other high temperature applications, including hypersonic missiles, booster motors, rockets, and other spacecraft.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

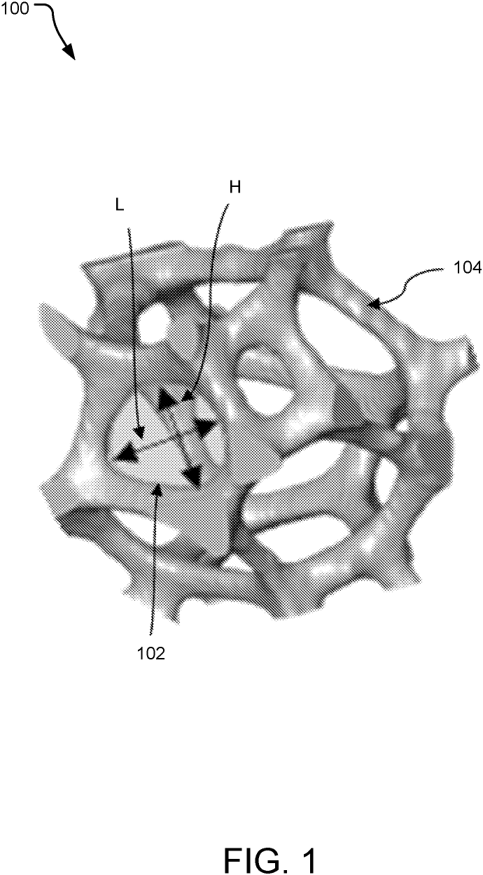

Turning to the figures, FIG. 1 shows an example of a reticulated, open cell foam structure 100, or, an open cell reticulated foam structure 100. The foam structure 100 has a plurality of pores 102 and a plurality of individual ligaments 104 forming the pores 102. The pores 102 are “connected” or “open,” allowing passage from one pore 102 to an adjacent pore 102.

The pores 102 have an area provided by a height H and a length L of the pore. The size of the pores 102, in either or both the height H and length L directions is about 5-150 pores/inch, in some embodiments about 10-100 pores/inch, and in other embodiments about 25-50 pores/inch; the depth of the pores (in the third dimension) is similar. The ligaments 104 have a diameter of about 100-3000 micrometers, in some embodiments 100-1000 micrometers. These variables for the pores 102 and ligaments 104 can be modified depending on the desired thermal requirements, pressure drop, surface pressure requirements and/or thermal duration of the final infiltrated product.

One particular example of a reticulated, open cell foam structure 100 is an aluminum material with 30-35 pores/inch, where each cell in the structure 100 is typically a 14-facted polyhedral framed by solid ligaments, with each face being a pore.

Another particular example of a foam structure 100 is a silicon carbide (SiC) structure having about 100 pores/inch.

Additional details regarding the foam structure 100, particularly, materials for the foam structure 100, are provided below.

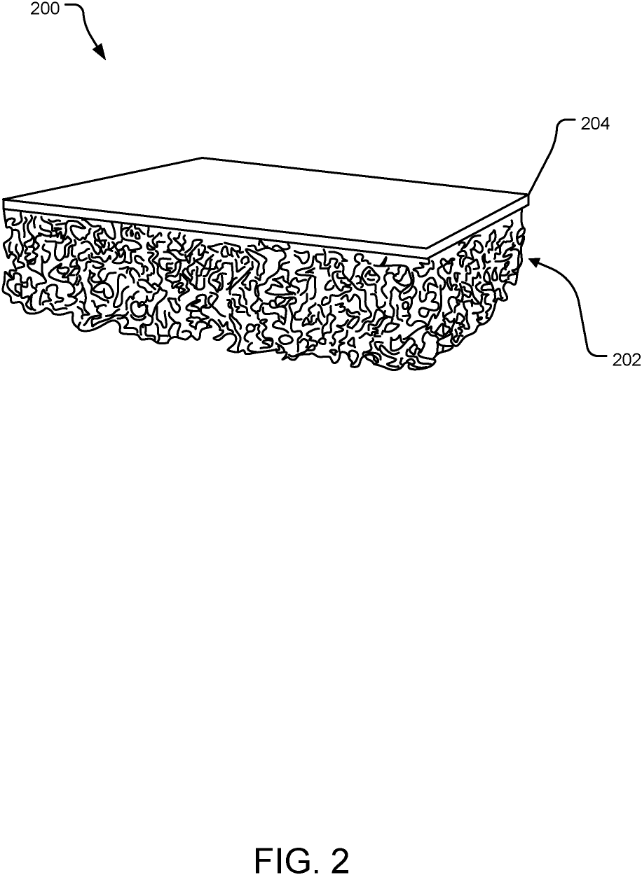

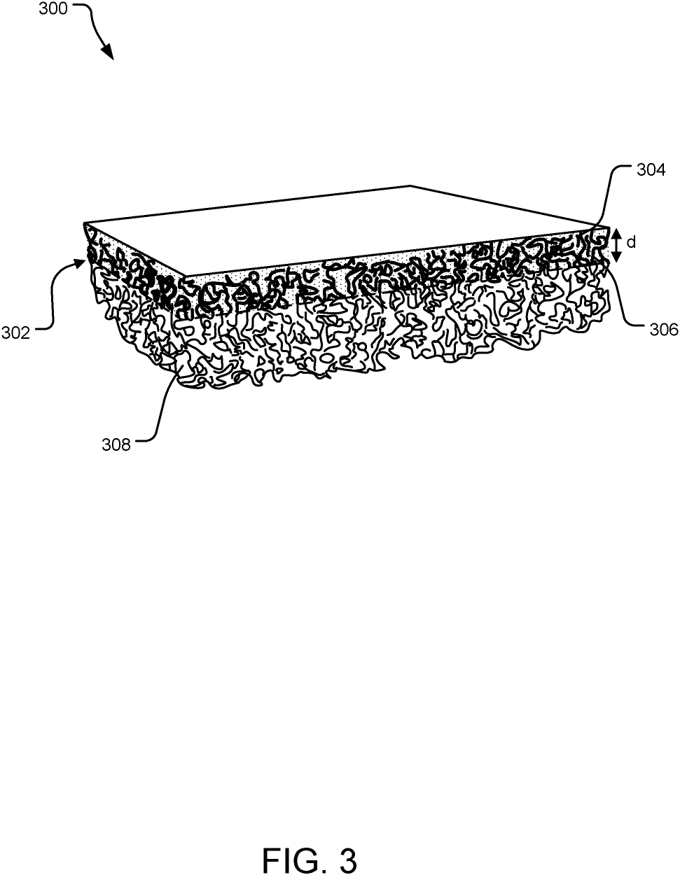

The foam structure 100 is provided with a coating of a MAX phase ceramic material to provide the final material or product, which is referred to herein as an infiltrated product. FIG. 2 shows an infiltrated product 200 having a foam structure with a layer of MAX phase ceramic material coated thereon and FIG. 3 shows an infiltrated product 300 having a foam structure with a MAX phase ceramic material infiltrated therein.

MAX phase materials are layered, hexagonal, ternary ceramic compounds that are carbides or nitrides having the general composition Mn+1AXn, where M is an early transition metal selected from Ti, V, Cr, Sc, Zr, Nb, Mo, Hf, and Ta; A is an A-group metal; X is either carbon or nitrogen; and the value of n is 1, 2, or 3. MAX phase ceramic materials exhibit a nanoscale laminated crystal structure of alternating MX and A layers, which provide them with a unique combination of ceramic and metallic properties, including high electrical and thermal conductivity, oxidation and corrosion resistance, machinability, and ultra-high temperature damage tolerance. A main characteristic of MAX phase materials is their unique combination of properties and the ability to be used to fill the gap between ceramic and metal composites.

Examples of MAX phase ceramic materials suitable for using in the product 200 and the product 300 include:
Ti₂CdC, Sc₂InC, Sc₂SnC,Ti₂AlC, Ti₂GaC, Ti₂InC, Ti₂TlC, V₂AlC, V₂GaC, Cr₂GaC,
Ti₂AlN, Ti₂GaN, Ti₂InN, V₂GaN, Cr₂GaN, Ti₂GeC, Ti₂SnC, Ti₂PbC, V₂GeC, Cr₂AlC,
Cr₂GeC, V₂PC, V₂AsC, Ti₂SC, Zr₂InC, Zr₂TlC, Nb₂AlC, Nb₂GaC, Nb₂InC, Mo₂GaC,
Zr₂InN, Zr₂TlN, Zr₂SnC, Zr₂PbC, Nb₂SnC, Nb₂PC, Nb₂AsC, Zr₂SC, Nb₂SC, Hf₂lnC,
Hf₂TlC, Ta₂AlC, Ta₂GaC, Hf₂SnC, Hf₂PbC, Hf₂SnN, Hf₂SC, Zr₂AlC, Ti₂ZnC, Ti₂ZnN,
V₂ZnC, Nb₂CuC, Mn₂GaC, Mo₂AuC, Ti₂AuN, Ti₃AlC₂, Ti₃GaC₂, Ti₃InC₂,
V₃AlC₂, Ti₃SiC₂, Ti₃GeC₂, Ti₃SnC₂, Ta₃AlC₂, Ti₃ZnC₂, Zr₃AlC₂, Ti₄AlN₃, V₄AlC₃,
Ti₄GaC₃, Ti₄SiC₃, Ti₄GeC₃, Nb₄AlC₃, Ta₄AlC₃, (Mo,V)₄, AlC₃, and Mo₄VAlC₄.

Additional details regarding MAX phase ceramic materials, particularly, how the MAX phase ceramic materials are incorporated into and onto the foam structure 100, are provided below.

Turning to FIG. 2, the infiltrated product 200 has an open cell reticulated foam structure 202 and a MAX phase ceramic material provided as a coating 204 on one side of the foam structure 202. The coating 204 has a thickness of, in some embodiments, at least 1/16 inch or at least ⅛ inch, and in other embodiments up to and even more than½ inch. Example thicknesses include ⅛ inch,¼ inch, and ⅜ inch. The thickness of the coating 204 can be tailored to obtain the desire thermal performance of the infiltrated product 200. It is noted that some amount of coating 204 may penetrate or infiltrate into the foam structure 202, to enhance adhesion of the coating 204 to the foam structure 202 by providing a mechanical bond and a chemical bond between the coating 204 and the foam structure 202.

Turning to FIG. 3, the infiltrated product 300 has an open cell reticulated foam structure 302 and a MAX phase ceramic material 304 infiltrated a depth “d” into the foam structure 302. The MAX phase ceramic material 304 is coated on ligaments 306 extending between pores 308 of the foam structure 302, or, the MAX phase ceramic material 304 is coating on the interior surfaces or walls of the pores 308. The MAX phase ceramic material 304 is infiltrated into the foam structure 302, in some embodiments, at least 1/16 inch or at least ⅛ inch, and in other embodiments up to and even more than 1 inch. Example impregnation depths d include ⅛ inch,¼ inch, ⅜ inch, ½ inch, and ¾ inch. The infiltration depth d of the MAX phase ceramic material 304, as well as its thickness on the ligaments 306, can be tailored to obtain the desired thermal performance of the infiltrated product 300.

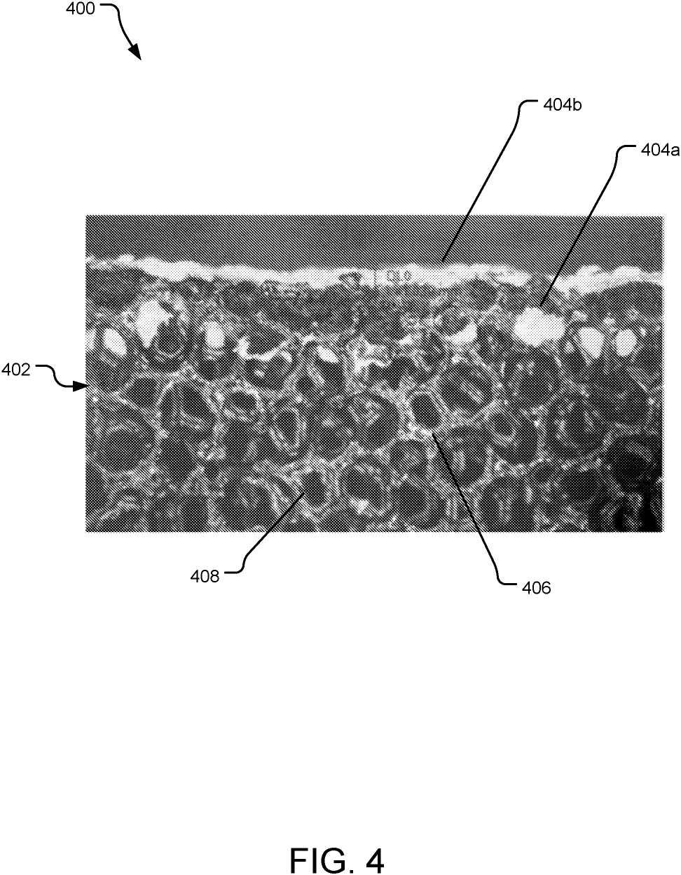

FIG. 4 shows an actual reticulated foam structure partially infiltrated with MAX phase material. In FIG. 4, an infiltrated product 400 has an open cell reticulated foam structure 402 and a MAX phase ceramic material 404 partially infiltrated into the foam structure 402. The MAX phase ceramic material 404a is present internal to the foam structure 402, coated on ligaments 406 and present in pores 408 of the foam structure 402. The MAX phase ceramic material 404b also forms a thin surface coating on the foam structure 402.

Conventionally, MAX phase ceramics are processed as solid pressed components, usually using hot pressing or hot isostatic pressing. These types of processes are time consuming, expensive, possibly distort the shape of the piece, and usually require machining the pieces after the processing to meet final part dimensions. The combination of these processes is costly, time consuming, and can result in quality control issues leading to mass part fall out. The infiltrated products of this disclosure, having a MAX phase ceramic material coated and/or infiltrated into an open cell reticulated foam structure, however, can be made by a low-cost and relatively simple process. Processing of the materials can be done via a pressureless firing or sintering process, such as in a near vacuum reactor, e.g., under an inert atmosphere. Additionally, the materials can be sized and shaped to the desired final product size and shape (near net shape) early in the processing, avoiding the need to shape, via e.g., machining, the sintered product.

The base of the infiltrated structure, the open cell reticulated foam, when in the final infiltrated product is a metal, metal-like, or ceramic material. At the beginning of the process, however, the open cell reticulated foam may be polymeric, metal, carbon, ceramic, or any other material suitable to make an open cell foam.

In one example process, an open cell polymeric foam (e.g., polystyrene, polyurethane, isocyanate, ethylene-vinyl acetate (EVA), polyethylene, polypropylene, polyimide, polyvinyl chloride (PVC), and nitrile rubber) is formed to the shape and size of the desired final infiltrated product. For example, the polymeric foam can be readily formed to the desired shape such as a cone or conical shape, an arcuate tile shape, or an intricate shape by hot knife or hot wire, water jet, knife or blade, or machined.

A hardening coating, such as SiC, TiC, VC, Cr₃C2, ZrC, NbC, Nb₂C, MoC, Mo₂C, TaC, or HfC, may be provided on the foam to strengthen and toughen the foam. The hardening coating may be provided by, e.g., vapor deposition (VD), chemical vapor deposition (CVD), plasma deposition, or other ion deposition method.

In another example processes, an open cell polymeric foam (e.g., polystyrene, polyurethane, isocyanate, ethylene-vinyl acetate (EVA), polyethylene, polypropylene, polyimide, polyvinyl chloride (PVC), and nitrile rubber), shaped and sized to the desired final infiltrated product, is pyrolyzed to produce a carbon skeleton of the foam; in some embodiments, the process can be carbonization.

In some embodiments, depending on the pyrolysis or carbonization conditions (temperature, time, atmosphere), the carbon skeleton exactly replaces the polymeric material, forming an identical structure of pores and ligaments as the original foam. In other embodiments, the carbon skeleton is an outer coating on the remaining polymeric material forming pores and ligaments. In yet other embodiments, the carbon skeleton is a hollow structure surrounding the previously-polymeric structure; in other words, the carbon skeleton is formed on the surface of the polymeric material, after which the polymeric material is carbonized or otherwise disappears.

A hardening coating, such as SiC, TiC, VC, Cr₃C₂, ZrC, NbC, Nb₂C, MoC, Mo₂C, TaC, or HfC, may be provided on the carbon skeleton to further strengthen and toughen the skeleton. The hardening coating may be provided by, e.g., vapor deposition (VD), chemical vapor deposition (CVD), plasma deposition, or other ion deposition method.

In one example process, an open cell metal foam is formed to the shape and size of the desired final infiltrated product. Examples of suitable metal foams include aluminum, copper, brass, titanium, nickel, platinum, steel, stainless steel, copper, silver, gold, zinc, and tin.

In another example process, an open cell ceramic foam is formed to the shape and size of the desired final infiltrated product.

In another example process, an open cell carbon or graphite foam is formed to the shape and size of the desired final infiltrated product.

In another example process, a metal carbide or metal nitride open cell foam is formed to the shape and size of the desired final infiltrated product. Examples of suitable foams include titanium carbide, vanadium carbide, chromium carbide, scandium carbide, zirconium carbide, niobium carbide, molybdenum carbide, hafnium carbide, tantalum carbide, titanium nitride, vanadium nitride, chromium nitride, scandium nitride, zirconium nitride, niobium nitride, molybdenum nitride, hafnium nitride and tantalum nitride.

The resulting sized and shaped open cell reticulated foam, whether a carbon skeleton, a polymeric foam, a metal foam, a metal nitride or carbide foam, carbon or graphite foam, or a ceramic foam, any with or without a hardening coating, is coated with the MAX phase ceramic material, either as a surface coating or infiltrated at least partially thereinto. Even with a surface coating of the MAX phase ceramic material, some amount of the MAX phase ceramic material will infiltrate at least somewhat into the cells of the foam structure.

To provide a surface coating of the MAX phase ceramic material, the MAX phase ceramic material, provided as a paste or slurry composed of solid particulate MAX phase material, can be coated onto the foam structure with a blade, knife coater, or merely manually wiped on. As indicated above, some amount of the MAX phase ceramic material will penetrate or infiltrate into the foam structure, as the paste or slurry drips or sags into the cells of the foam structure, based on pore size. The viscosity of a paste or slurry of MAX phase ceramic particulate is dependent on the pore size and pores/inch, but will generally be from about 80 cps for fine pore foam structures to over 60,000 cps.

To infiltrate the MAX phase ceramic material into the foam structure, the MAX phase ceramic material is provided as slurry composed of solid particulate MAX phase material and can be coated onto the foam structure with a spray coater, blade, knife coater, or merely manually wiped on. The viscosity of the slurry and the amount of slurry applied will affect the depth to which the MAX phase ceramic material penetrates or infiltrates into the foam structure, based on pore size and pore/inch of the foam structure. Typically, the viscosity of a slurry of MAX phase ceramic particulate will generally be from about 80 cps to 60,000 cps.

In some designs, multiple layers of the MAX phase ceramic material may be applied; the multiple layers may be the same MAX phase ceramic or different. As an example, a first MAX phase ceramic material can be infiltrated into the foam structure and a second MAX phase ceramic material can be applied as a surface coating. As another example, a first MAX phase ceramic material can be infiltrated to a depth of (e.g.,) ½ inch and a second MAX phase ceramic material can be infiltrated to a depth of (e.g.,) ¼ inch, resulting in the first ¼ inch having the second MAX phase ceramic material as the exposed material on the ligaments and the second ¼ inch having the first MAX phase ceramic material as the exposed material on the ligaments.

The solid particulate MAX phase material in the paste or slurry may have an average particle size from about 1 micrometer to about 25 micrometers. The solvent in which the particulates are suspended may be an aqueous or organic solvent, such as water, ethanol, methanol, isopropyl alcohol, methyl ethyl ketone (MEK), or toluene. The paste or slurry may include a binder, surfactant, dispersant, defoamer or any other additive such as adjuvants to, e.g., inhibit electromagnetic waves or impulses (EMI), microwaves, or radiation (e.g., gamma radiation). Sintering aids may be included in the paste or slurry.

After coating the slurry or paste on the foam structure, the coating of MAX phase material may be dried (e.g., room temperature or in an oven) prior to being sintered to densify the MAX phase material. The sintering may be at, e.g., 1270 to 1455° C. for a time period of 1-6 hours, depending on the MAX phase material and its thickness or depth into the foam structure. The sintering is done as a low-pressure or pressureless process, no greater than at 5 psi. The sintering can be done in a near vacuum reactor, e.g., under an inert atmosphere. After sintering, the final infiltrated product is obtained.

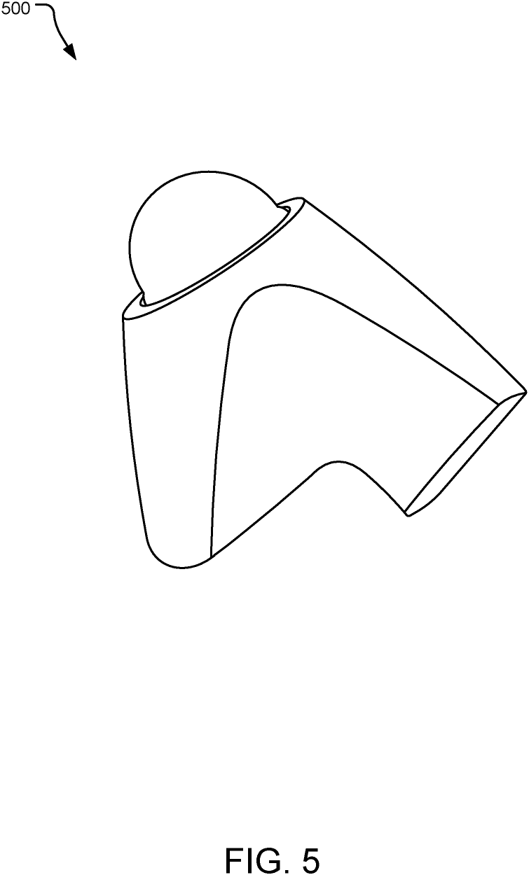

FIG. 5 shows an infiltrated product 500 having an intricate surface. To form the product 500, the beginning open foam reticulated structure (e.g., foam structure 100, 202, 302) was shaped and sized to the same shape and size of the final infiltrated product 500; that is, the beginning open foam reticulated structure had a near net shape to the final infiltrated product 500. MAX phase ceramic material was coated on the desired surface to the desired infiltration depth. The coated structure was then sintered in a low pressure reactor.

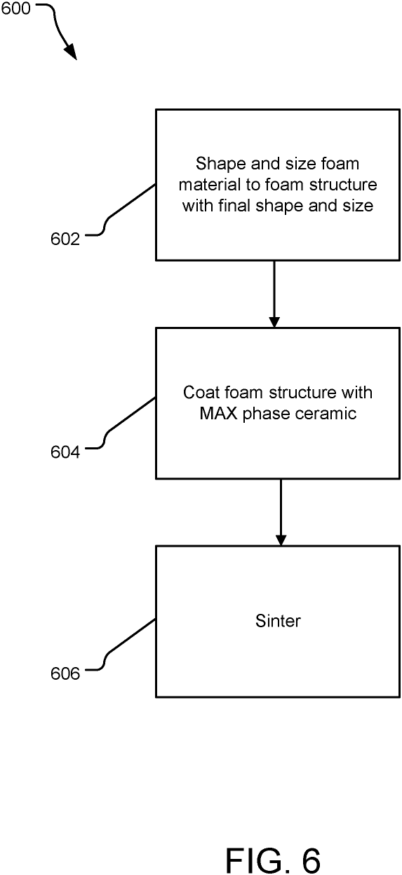

FIG. 6 shows a general method 600 for preparing an open foam reticulated product having an infiltrated MAX phase material. In a first step 602, a foam material is shaped and sized to form a foam structure having the shape and size of the desired final infiltrated product. In a second step 604, the foam structure is coated with a MAX phase ceramic material. The MAX phase ceramic material is sintered at low pressure or pressurelessly in a step 606 to obtain the final infiltrated product.

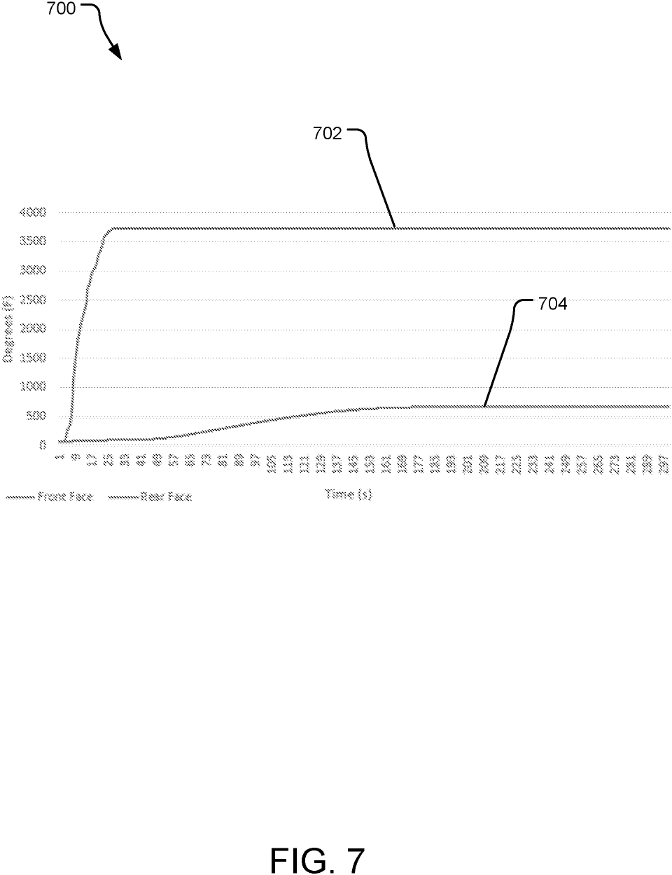

FIG. 7 shows the thermal performance of an infiltrated product, particularly, the cooling effect of an example of a 0.5 inch thick, SiC open foam reticulated structure having an infiltrated Ti₃SiC₂ MAX phase ceramic material. The MAX phase side of the infiltrated product (the front face) was heated to a hot side temperature in excess of 2050 degree C with a benzene torch at Mach 4 flame pressure. Line 602 of the graph 600 shows the temperature on the front face as a function of time. The line 604 shows the temperature at the back side face of the infiltrated product. After about 60 seconds, the temperature of the back face began to increase to a maximum temperature of about 170 degree C. No weight loss of the infiltrated product was measured after the torch test after almost 5 minutes of burn time with a Mach 4 flame pressure.

Thus, described herein is a material comprising MAX phase ceramic material layered within and above an open celled reticulated foam; also described herein is a material comprising MAX phase material infiltrated into an open celled reticulated foam. The MAX phase material can be applied to the open celled reticulated foam manually, by spraying, or by other mechanical application. The MAX phase material is present as a layer on the ligaments of the open cell reticulated foam, coating the inner surfaces of the pores of the foam structure.

The combination of porous material and thermal coating enables the porous material to support cooling medium such as air, phase change material, water, saline, or other mediums that support cooling of the thermal coating while passing through the porous material. The infiltrated material can be placed in contact with or in a pathway of a heat source.

The resulting infiltrated product is capable of withstanding elevated temperatures, e.g., in excess of 2100° C. and even 2400 degree C, depending on the particular MAX phase ceramic material and its depth of infiltration into the foam structure. The open celled reticulated foam, into which the MAX phase ceramic material is coated, may be an ultra-high temperature foam material.

The infiltrated product could be used to direct heat away from equipment, such as a parabolic disc to a specific point. Such a directed structure could produce an intense heat that could be applicable for directed energy weapons, for incineration equipment, for propulsion devices, hyper sonic systems, communication applications, or even simple solar arrays. The structure could be used in environments where excess heat is involved yet undesired, such as a receiving antenna. In addition to the natural cooling providing by the open cells of the foam structure, the infiltrated product can be cooled from an uncoated side (e.g., backside or side). Cooling can be done by a cooling medium such as air, water, salt water or saline, or sodium.

Additionally, the infiltrated product can be used to shield electronic components, e.g., electrical circuits, electronic bonds, computer systems, from high energy pulses, electromagnetic surges, microwaves, and lasers.

Other applications for the infiltrated product include as a material for lining, tubing, shielding, and high temperature furnaces, and any systems using laser, microwave, or light heating sources. Any lining, tubing, shielding, etc. may be formed from the infiltrated product or the infiltrated product may be a portion thereof. The infiltrated product is also suitable within jet engine or combustion engines.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

1. A product comprising:
an open cell reticulated foam structure comprising a plurality of ligaments forming a plurality of pores; and
a MAX phase ceramic material infiltrated into the foam structure and present on the ligaments and coating interior surfaces of the pores.

2. The product of claim 1, wherein the MAX phase ceramic material is infiltrated into the foam structure at least ⅛ inch.

3. The product of claim 1, wherein the MAX phase ceramic material in infiltrated into the foam structure ⅛ inch to ½ inch.

4. The product of claim 1, wherein the open cell reticulated foam structure is a polymeric foam, a metal foam, a metal nitride or carbide foam, carbon or graphite foam, or a ceramic foam.

5. The product of claim 1, wherein the open cell reticulated foam structure has 10-100 pores/inch.

6. A method of making a product, the method comprising:
providing an open cell reticulated foam structure;
infiltrating a MAX phase ceramic material at least partially into the open cell reticulated foam structure; and
after infiltrating the MAX phase ceramic material into the foam structure, sintering the MAX phase ceramic material at a pressure less than 5 psi.

7. The method of claim 6, wherein sintering the MAX phase ceramic material at a pressure less than 5 psi comprises:
pressurelessly sintering the MAX phase ceramic material.

8. The method of claim 6, wherein sintering the MAX phase ceramic material at a pressure less than 5 psi comprises:
sintering the MAX phase ceramic material in a reactor under near vacuum pressure.

9. The method of claim 8, wherein sintering the MAX phase ceramic material in a reactor under near vacuum pressure comprises:
sintering the MAX phase ceramic material in a reactor under near vacuum pressure in an inert atmosphere.

10. The method of claim 6, wherein providing the open cell reticulated foam structure comprises:
providing a metal or ceramic open cell reticulated foam structure.

11. The method of claim 6, wherein providing the open cell reticulated foam structure comprises:
providing a polymeric open cell reticulated foam structure; and
pyrolyzing the polymeric open cell reticulated foam structure.

12. The method of claim 11, further comprising applying a hardening coating on the pyrolyzed open cell reticulated foam structure.

13. The method of claim 6, wherein infiltrating the MAX phase ceramic material at least partially into the open cell reticulated foam structure comprises:
applying a paste or slurry comprising MAX phase ceramic material particulates onto the open cell reticulated foam structure.

14. The method of claim 13, wherein infiltrating the MAX phase ceramic material at least partially into the open cell reticulated foam structure comprises:
applying the paste with a blade, a knife coater, or manually wiping the paste onto the open cell reticulated foam structure.

15. The method of claim 13, wherein infiltrating the MAX phase ceramic material at least partially into the open cell reticulated foam structure comprises:
applying with slurry with a blade, a knife coater, spray coater, or manually wiping the slurry onto the open cell reticulated foam structure.

16. The method of claim 13, wherein infiltrating the MAX phase ceramic material at least partially into the open cell reticulated foam structure comprises:
infiltrating the paste or slurry at least ⅛ inch into the open cell reticulated foam structure.

17. The method of claim 6, wherein providing the open cell reticulated foam structure comprises:
providing the open cell reticulated foam structure having a shape and size of the product.
